(19) United States
(12) Patent Application Publication
(10) Pub. No.: US 2021/0134491 A1
(43) Pub. Date: May 6, 2021

(54) WIRE AND METHOD FOR MANUFACTURING SAME

(71) Applicant: FUJIKURA LTD., Tokyo (JP)

(72) Inventors: Yuki Nakamura, Sakura-shi (JP); Chihiro Kamidaki, Sakura-shi (JP); Ryujiro Nomura, Sakura-shi (JP)

(73) Assignee: FUJIKURA LTD., Tokyo (JP)

(21) Appl. No.: 16/491,964

(22) PCT Filed: Mar. 6, 2018
(86) PCT No.: PCT/JP2018/008617

§ 371 Date: Sep. 6, 2019

(30) Foreign Application Priority Data
Mar. 10, 2017 (JP) 2017-046682

(51) Int. Cl. H01B 13/00; B21C 1/00; H01F 5/06; H01B 13/08

(52) U.S. Cl. CPC H01B 13/0036; H01B 13/08; H01F 5/06; B21C 1/00

(57) ABSTRACT

A method for manufacturing a wire includes: preparing a tubular outer layer body including a magnetic metal containing iron; preparing a metal core body having an outer diameter that is 85.1% or more and 99.4% or less of an inner diameter of the tubular outer layer body; mechanically polishing an inner surface of the tubular outer layer body and an outer surface of the metal core body; treating at least one of the inner surface of the tubular outer layer body and the outer surface of the metal core body with hydrochloric acid; obtaining a preform by disposing the metal core body inside the tubular outer layer body; and obtaining a wire by drawing the preform through a wire drawing die.

### CROSS-REFERENCE TO RELATED APPLICATIONS

This is a U.S. national stage application of International application No. PCT/JP2018/008617, filed on Mar. 6, 2018, which claims priority from Japanese Patent Application No. 2017-046682, filed on Mar. 10, 2017. The contents of these applications are incorporated herein in their entirety.

### TECHNICAL FIELD

The present invention relates to a wire and a method for manufacturing the same.

### BACKGROUND

Wires having a structure in which a layer formed of a magnetic metal is provided on the outer circumference of a metallic wire are being used (for example, refer to Patent Document 1). An enamel wire described in Patent Document 1 has an insulating coating and a magnetic metal-plated layer provided on the outer circumference of a copper wire or the like.

In order to produce the above-described enamel wire, the insulating coating is formed on the outer circumference of the copper wire or the like, and then the magnetic metal-plated layer is formed on the outer circumference of the insulating coating using a plating method.

[Patent Document 1] Japanese Unexamined Patent Application, First Publication No. 2003-77719

However, in a method for manufacturing the enamel wire, when the magnetic metal-plated layer is formed to be thick, the magnetic permeability of the magnetic metal-plated layer is likely to decrease. Therefore, in the case of applying the enamel wire to a coil in a high-frequency device, there is a likelihood that high-frequency resistance may cause a decrease in the electric power transmission efficiency and the generation of heat. In addition, the hardness of the magnetic metal-plated layer is likely to increase, and thus this enamel wire is likely to break while being coiled and cannot be easily handled.

### SUMMARY

One or more embodiments of the present invention provide a wire that is excellent in terms of magnetic characteristics and does not easily break even when a magnetic metal layer is formed to be thick and a method for manufacturing the same.

A method for manufacturing a wire according to one or more embodiments of the present invention includes preparing a tubular outer layer body formed of a magnetic metal containing iron and a core body (metal core body) that is formed of a metal and has an outer diameter that is 85.1% or more and 99.4% or less of an inner diameter of the outer layer body, carrying out mechanical polishing on an inner surface of the outer layer body and an outer surface of the core body, treating at least one of the inner surface of the outer layer body and the outer surface of the core body with hydrochloric acid, disposing the core body inside the outer layer body to obtain a preform, and drawing the preform through a wire drawing die, thereby obtaining a wire having a central conductor formed of the core body and an outer layer that is formed of the outer layer body and that covers the central conductor.

A method for manufacturing a wire according to one or more embodiments of the present invention includes preparing a tubular outer layer body formed of a magnetic metal containing iron and a core body that is formed of a metal and has an outer diameter that is 85.1% or more and 99.4% or less of an inner diameter of the outer layer body, carrying out mechanical polishing on an inner surface of the outer layer body and an outer surface of the core body so as to form a screw-shaped polishing mark around an axis of the core body, disposing the core body inside the outer layer body to obtain a preform, and drawing the preform through a wire drawing die, thereby obtaining a wire having a central conductor formed of the core body and an outer layer that is formed of the outer layer body and that covers the central conductor.

At least one of the inner surface of the outer layer body and the outer surface of the core body may be treated with an acid.

In the wire drawing of the preform, an area reduction ratio in the wire drawing by one time may be 10% or more and 20% or less.

A wire according to one or more embodiments of the present invention includes a central conductor formed of a metal and an outer layer that is formed of a magnetic metal containing iron, has a thickness of 3 μm or more and a Vickers Hardness of less than 350 Hv, and covers the central conductor.

A Cl concentration of the outer layer may be 0.1 wt % or less.

A high-frequency coil according to one or more embodiments of the present invention includes a support having a trunk portion around which the wire is wound.

A method for manufacturing a high-frequency coil according to one or more embodiments of the present invention includes winding the wire around the trunk portion.

According to the above-described embodiments of the present invention, unlike a manufacturing method in which a plating method is used, it is possible to decrease the concentration of an impurity (for example, chlorine or the like) that is included in the outer layer. Since the concentration of the impurity in the outer layer decreases, the magnetic characteristic distribution in the outer layer becomes uniform, and the magnetic characteristics do not easily degrade even when the outer layer is formed to be thick.

Therefore, in the case of applying the wire to a coil in a high-frequency device, it is possible to avoid a decrease in the electric power transmission efficiency and the generation of heat caused by high-frequency resistance.

In addition, according to one or more embodiments of the manufacturing method, compared with a manufacturing method in which a plating method is used, the hardness of the outer layer can be suppressed to be low. Therefore, during the coiling of the wire, the wire does not easily break. Therefore, a wire having excellent handleability can be obtained.

Furthermore, according to one or more embodiments of the manufacturing method, compared with a manufacturing method in which a plating method is used, the time necessary to form the outer layer can be shortened. In addition, it is also possible to cut the waste liquid treatment cost. Therefore, the manufacturing cost can be reduced.

### BRIEF DESCRIPTION OF DRAWINGS

FIG. 1 is a cross-sectional view showing a wire according to one or more embodiments.

FIG. 2 is a cross-sectional view showing a preform that is used in a method for manufacturing a wire according to one or more embodiments.

FIG. 3 is a cross-sectional view showing a preform for which a modification example of an outer layer body is used according to one or more embodiments.

FIG. 4 is a pattern diagram showing an example of a wire drawing die according to one or more embodiments.

FIG. 5 is a cross-sectional view showing a first modification example of the wire in FIG. 1.

FIG. 6 is a perspective view showing an example of a coil for which the wire in FIG. 5 is used.

FIG. 7 is a cross-sectional view showing a second modification example of the wire according to one or more embodiments.

### DETAILED DESCRIPTION

[Wire]

A wire according to one or more embodiments of the present invention includes, for example, a central conductor formed of a metal and an outer layer that is formed of a magnetic metal containing iron, has a thickness of 3 μm or more and a Vickers Hardness of less than 350 Hv, and covers the central conductor.

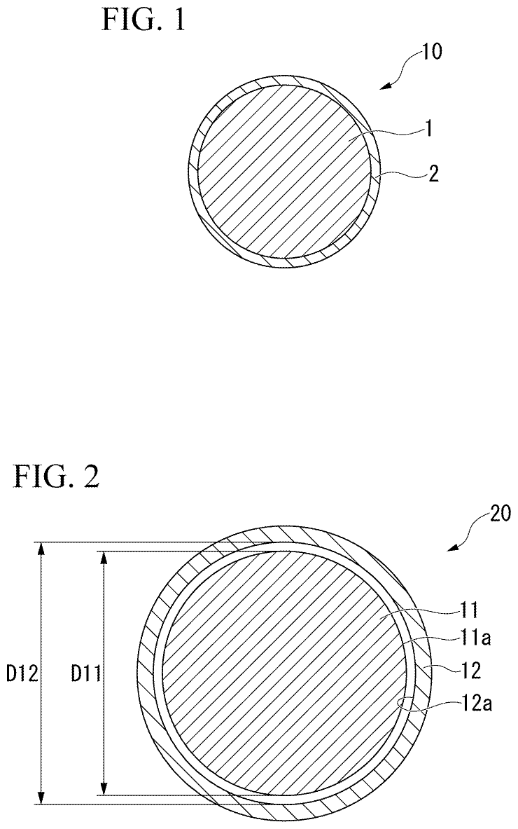

FIG. 1 is a cross-sectional view showing a wire 10 according to one or more embodiments of the present invention. FIG. 1 is a view showing a cross section of the wire 10 perpendicular to the longitudinal direction.

As shown in FIG. 1, the wire 10 is a conductor having a bilayer structure including a central conductor 1 and an outer layer 2 that covers the central conductor 1.

The central conductor 1 is formed of a metal. As the metal that forms the central conductor 1, high-conductivity metals such as an aluminum-containing material and a copper-containing material may be used.

As the aluminum-containing material, aluminum (Al) and an aluminum alloy can be used. For example, aluminum for electrical purposes (EC aluminum), an Al-Mg-Si-based alloy (JIS6000 series), and the like can be used.

As the copper-containing material, copper (Cu) and a copper alloy can be used. The forming material of the central conductor 1 may be an alloy material containing both aluminum and copper. The forming material of the central conductor 1 may be a non-magnetic material or a magnetic material.

The central conductor 1 has a round shape in a cross section perpendicular to the longitudinal direction.

The outer layer 2 is formed of a magnetic metal containing iron. As the magnetic metal, iron (Fe) and an iron alloy can be used.

As the iron alloy, a FeSi-based alloy (FeSiAl, FeSiAlCr, or the like), a FeAl-based alloy (FeAl, FeAlSi, FeAlSiCr, FeAlO, or the like), a FeCo-based alloy (FeCo, FeCoB, FeCoV, or the like), a FeNi-based alloy (FeNi, FeNiMo, FeNiCr, FeNiSi, or the like) (permalloy or the like), a FeTa-based alloy (FeTa, FeTaC, FeTaN, or the like), a FeMg-based alloy (FeMgO or the like), a FeZr-based alloy (FeZrNb, FeZrN, or the like), a FeC-based alloy, a FeN-based alloy, a FeP-based alloy, a FeNb-based alloy, a FeHf-based alloy, a FeB-based alloy, and the like are exemplified.

The outer layer 2 is formed of the magnetic metal and is thus capable of suppressing the intrusion of a magnetic field into the central conductor 1.

The thickness of the outer layer 2 is set to 3 μm or more or may be set to 10 μm or more. When the thickness of the outer layer 2 is set to 3 μm or more, it is possible to sufficiently enhance an effect for preventing a decrease in the electric power transmission efficiency and the generation of heat in the case of applying the wire to a coil in a high-frequency device.

The thickness of the outer layer 2 can be set to, for example, 1,000 μm or less. When the thickness of the outer layer 2 exceeds 1,000 μm, in high-frequency uses, the influence of the skin effect is strong, and the current flows only on the surface of a wire rod, and thus the amount of a current that is caused to flow decreases. On the other hand, when a plurality of lines in which the thickness of the outer layer 2 is 1,000 μm or less is prepared, the surface area increases, and the amount of a current that is caused to flow also increases.

The thickness of the outer layer 2 is desirably uniform around the axis of the wire 10.

The cross-sectional area of the outer layer 2 can be set to be 20% or less of the cross-sectional area of the entire wire 10 that is the combination of the central conductor 1 and the outer layer 2. The cross-sectional area ratio (the cross-sectional area ratio of the outer layer 2 to the entire wire 10) is desirably 3% to 15% and more desirably 3% to 5%.

The outer diameter of the outer layer 2 can be set to, for example, 0.05 mm to 0.6 mm.

The Vickers hardness of the outer layer 2 may be less than 350 Hv. When the Vickers hardness of the outer layer 2 is set to be in this range (less than 350 Hv), in the case of bending the wire 10 during, for example, the production of a coil using the wire 10, the wire 10 does not easily break.

The Vickers hardness can be measured according to, for example, JIS Z 2244:2009.

The chlorine (Cl) concentration of the outer layer 2 may be 0.1 wt % or less. When the chlorine (Cl) concentration of the outer layer 2 is set to be in this range (0.1 wt % or less), it is possible to make the magnetic characteristics of the wire 10 favorable.

The chlorine (Cl) concentration can be measured using, for example, EPMA (for example, “JXA-8900M” manufactured by JEOL Ltd.) (measurement conditions: a voltage of 15 kV and a probe current of 5×10⁻⁸ A).

In the wire 10, an intermetallic compound layer (not shown) having a composition that gradually changes toward the outer layer 2 from the central conductor 1 may be formed between the central conductor 1 and the outer layer 2. The intermetallic compound layer is formed of, for example, an alloy including the forming material of the central conductor 1 and the forming material of the outer layer 2.

[Method for Manufacturing Wire]

In a method for manufacturing a wire according to one or more embodiments of the present invention, a tubular outer layer body formed of a magnetic metal containing iron and a core body that is formed of a metal and has an outer diameter that is 85.1% or more and 99.4% or less of the inner diameter of the outer layer body are prepared, mechanical polishing is carried out on the inner surface of the outer layer body and the outer surface of the core body, at least one of the inner surface of the outer layer body and the outer surface of the core body is treated with hydrochloric acid, the core body is disposed inside the outer layer body to obtain a preform, and the preform is drawn through a wire drawing die, thereby obtaining a wire having a central conductor formed of the core body and an outer layer that is formed of the outer layer body and that covers the central conductor.

Next, the method for manufacturing a wire according to one or more embodiments will be described using a method for manufacturing the wire 10 shown in FIG. 1 as an example.

<Step of Producing Preform>

FIG. 2 is a cross-sectional view showing a preform 20 that is used in the method for manufacturing a wire according to one or more embodiments.

As shown in FIG. 2, a core body 11 and an outer layer body 12 are prepared.

The core body 11 is formed of a metal that is the forming material of the central conductor 1, for example, the aluminum-containing material, the copper-containing material, or the like. The core body 11 has a shape in which the cross section perpendicular to the longitudinal direction becomes round.

The outer layer body 12 is formed of a magnetic metal that is the forming material of the outer layer 2, for example, the FeNi-based alloy (permalloy or the like) or the like.

The outer layer body 12 is formed in a cylindrical shape (tubular shape), and, it is possible to use, for example, a raw material of an iron tube or a steel tube. The outer layer body 12 is continuously formed so as to be seamless throughout the entire circumstance of the cylinder. The outer layer body 12 is, for example, a rolled material. As a cylindrical raw material that is used to form the outer layer body 12, a material in which the amount of an impurity such as chlorine is small may be used. For example, a raw material in which the concentration of chlorine (Cl) is 0.1 wt % or less may be used. The thickness of the outer layer body 12 is desirably uniform around the axis of the preform 20.

The core body 11 is inserted into the outer layer body 12, thereby disposing the core body 11 inside the outer layer body 12. Therefore, the preform 20 is obtained. The preform 20 has a structure in which the core body 11 and the outer layer body 12 that surrounds the core body 11 are provided.

The ratio of an outer diameter D11 of the core body 11 to an inner diameter D12 of the outer layer body 12, that is, “D11/D12” may be 85.1% or more and 99.4% or less.

When the diameter ratio (D11/D12) is 85.1% or more, during the wire drawing of the preform 20, the central axis of the core body 11 and the central axis of the outer layer body 12 do not easily deviate from each other, and an appropriate stress for the joining of the core body 11 and the outer layer body 12 can be obtained using a wire drawing die. In addition, the central axis of the core body 11 and the central axis of the outer layer body 12 do not easily deviate from each other, and thus the thickness of the outer layer 2 does not easily become uneven. Therefore, the outer layer 2 does not easily break due to the concentration of stress at a thin place of the outer layer 2.

When the diameter ratio (D11/D12) is 99.4% or less, an operation of inserting the core body 11 into the outer layer body 12 becomes easy.

On an outer surface 11a of the core body 11 and an inner surface 12a of the outer layer body 12, mechanical polishing is carried out.

The mechanical polishing can be carried out using, for example, a polishing tool such as a film, a drill, or a brush. A polishing agent (abrasive grain) may also be used with the polishing tool. The mechanical polishing roughens the outer surface 11a of the core body 11 and the inner surface 12a of the outer layer body 12, and fine surface protrusions and recesses can be formed. In addition, the mechanical polishing removes an oxide film on the outer surface 11a of the core body 11 and the inner surface 12a of the outer layer body 12.

The arithmetic surface roughness Ra (JIS B 0601 (2013)) of the outer surface 11a and the inner surface 12a that have been mechanically polished may be set to, for example, 10 μm or more and 200 μm or less.

By the mechanical polishing, the outer surface 11a of the core body 11 and the inner surface 12a of the outer layer body 12 is roughened and fine surface protrusions and recesses is formed, in a wire drawing step described below. Thereby, the joining of the core body 11 and the outer layer body 12 becomes easy. Therefore, when the wire 10 becomes fine in a wire drawing process, an excess stress does not apply to the outer layer 2, and wire drawing becomes possible without causing wire breakage.

At least one of the outer surface 11a of the core body 11 and the inner surface 12a of the outer layer body 12 is treated with hydrochloric acid (acid treatment agent). The concentration of the hydrochloric acid can be set to, for example, 0.1 mol/l to 12.1 mol/l (or 1 mol/l to 7 mol/l). The pH of the acid treatment agent is, for example, 2 or less.

The temperature condition of the treatment with hydrochloric acid is, for example, 10° C. to 40° C., but the treatment with an acid may be carried out under a heating condition of higher than 40° C.

For the treatment with hydrochloric acid, the core body 11 and the outer layer body 12 may be immersed in the acid treatment agent.

The treatment time of the treatment with hydrochloric acid may be set to, for example, 1 to 30 minutes (or 1 to 10 minutes).

The treatment with hydrochloric acid removes an oxide film on the outer surface 11a of the core body 11 and the inner surface 12a of the outer layer body 12. The removal of the oxide film facilitates the joining of the core body 11 and the outer layer body 12 in the wire drawing step described below.

The treatment with hydrochloric acid may be carried out on both the outer surface 11a of the core body 11 and the inner surface 12a of the outer layer body 12 or may be carried out only one of the outer surface 11a of the core body 11 and the inner surface 12a of the outer layer body 12.

The order of the treatment with hydrochloric acid and the mechanical polishing is not particularly limited, and the treatment with hydrochloric acid may be carried out earlier or the mechanical polishing may be carried out earlier.

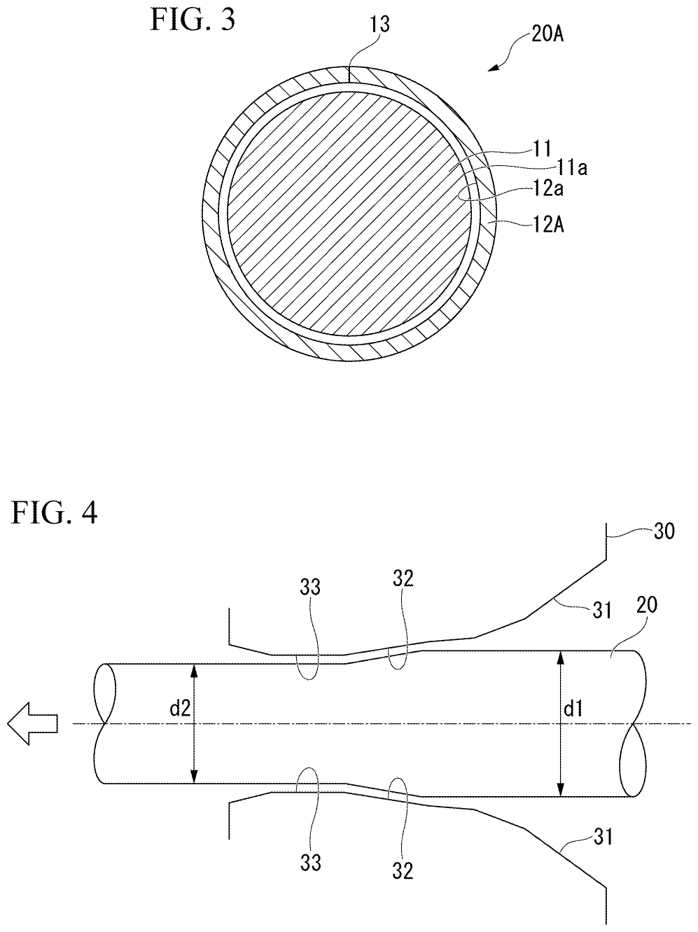

In the manufacturing method according to one or more embodiments, a preform 20A shown in FIG. 3 may also be used instead of the preform 20 shown in FIG. 2.

FIG. 3 is a view showing the preform 20A for which an outer layer body 12 that is a modification example of the outer layer body 12 is used in accordance with one or more embodiments.

As shown in FIG. 3, the outer layer body 12A is formed in a cylindrical shape (tubular shape). The outer layer body 12A is different from the outer layer body 12 shown in FIG. 2 in terms of the fact that there is a place (joint) 13 at which the outer layer body becomes discontinuous in a part around the axis.

The outer layer body 12A can be formed in a cylindrical shape (tubular shape) by bending a band-shaped (ribbon-shaped) or flat plate-shaped raw material in a state of longitudinally lapping the core body 11 so as to wrap the core body 11. The band-shaped or flat plate-shaped raw material is, for example, a rolled material. As the band-shaped or flat plate-shaped raw material that is used to form the outer layer body 12A, a material in which the amount of an impurity such as chlorine is small may be used. For example, a raw material in which the concentration of chlorine (Cl) is 0.1 wt % or less may be used.

In the preform 20A as well, similar to the preform 20 (refer to FIG. 2), the ratio of the outer diameter of the core body 11 to the inner diameter of the outer layer body 12A may be 85.1% or more and 99.4% or less.

<Wire Drawing Step>

FIG. 4 is a pattern diagram showing a wire drawing die 30 that can be applied to the manufacturing method according to one or more embodiments.

As shown in FIG. 4, the wire drawing die 30 has a structure in which the inner diameter gradually decreases from an entrance portion 31 to a reduction portion 32.

The preform 20 is introduced to the reduction portion 32 through the entrance portion 31 and processed to a diameter d2 that is smaller than a diameter d1 that is the diameter before wire drawing.

The wire drawing process may be carried out by only one time (in a single pass), but the area reduction ratio can be increased by carrying out the wire drawing process a plurality of times (in multiple passes) using other wire drawing dies 30 having different inner diameter dimensions. That is, the preform 20 can be wire-drawn stepwise using a plurality of wire drawing dies 30.

The area reduction ratio in the wire drawing process by one time (in a single pass) can be set to, for example, 10% or more. The area reduction ratio in the wire drawing process by one time can be set to, for example, 20% or more. When the area reduction ratio in the wire drawing process by one time is set to 10% or more, it is possible to increase the efficiency of the wire drawing process. When the area reduction ratio in the wire drawing process by one time is set to 20% or more, it is possible to suppress a shear force that is applied to the outer layer body 12 and prevent the breakage of the wire (for example, wire breakage).

The area reduction ratio is “the difference in cross-sectional area before and after the wire drawing of the preform 20/the cross-sectional area before the wire drawing of the preform 20”. The area reduction ratio can be calculated from the cross-sectional area of the preform 20 perpendicular to the axial direction of the preform 20 and the cross-sectional area perpendicular to the axial direction of the bearing portion 33 in an inner space of the bearing portion 33.

The cumulative area reduction ratio can be set to, for example, 70% or more.

The wire 10 shown in FIG. 1 can be obtained by the above-described wire drawing.

In the manufacturing method according to the above-described embodiments, the preform 20 having the core body 11 disposed inside the outer layer body 12 is produced, and then the preform 20 is wire-drawn, thereby obtaining the wire 10.

In the manufacturing method according to one or more embodiments, unlike a manufacturing method in which a plating method is used, an impurity (for example, chlorine or the like) is not easily mixed into the outer layer 2. In the manufacturing method in which a plating method is used, an impurity (for example, chlorine or the like) included in a plating liquid remains in a plated film, and thus an outer layer including a large amount of the impurity is formed. According to the manufacturing method according to the above-described embodiments, no impurity is mixed into the outer layer 2 during the process, and thus the concentration of an impurity in the outer layer 2 becomes smaller than that in a case where the outer layer is formed using a plating method. Therefore, the magnetic characteristic distribution of the outer layer 2 becomes uniform, and the magnetic characteristic do not easily degrade even when the outer layer 2 is formed to be thick. Therefore, in the case of applying the wire 10 to a coil in a high-frequency device, it is possible to avoid a decrease in the electric power transmission efficiency and the generation of heat caused by high-frequency resistance.

In addition, in the manufacturing method according to one or more embodiments, compared with the manufacturing method in which a plating method is used, the hardness of the outer layer 2 can be suppressed to be low. Therefore, during the coiling of the wire 10, the wire 10 does not easily break. Therefore, the wire 10 having excellent handleability can be obtained.

Furthermore, according to the manufacturing method according to one or more embodiments, compared with the manufacturing method in which a plating method is used, the time necessary to form the outer layer 2 can be shortened. In addition, it is also possible to cut the waste liquid treatment cost. Therefore, the manufacturing cost can be reduced.

The wire 10 is manufactured using the above-described manufacturing method, and thus an impurity (for example, chlorine or the like) is not easily mixed into the outer layer 2. The concentration of an impurity in the outer layer 2 is small, the magnetic characteristic distribution of the outer layer 2 becomes uniform, and the magnetic characteristic do not easily degrade even when the outer layer 2 is formed to be thick. Therefore, in the case of applying the wire 10 to a coil in a high-frequency device, it is possible to avoid a decrease in the electric power transmission efficiency and the generation of heat caused by high-frequency resistance.

In addition, in the wire 10, as described above, the hardness of the outer layer 2 can be suppressed to be low. Therefore, during the coiling of the wire 10, the wire 10 does not easily break. Therefore, the wire 10 having excellent handleability can be obtained.

Furthermore, as described above, the wire 10 is capable of reducing the manufacturing cost.

[Method for Manufacturing Wire]

In a method for manufacturing a wire according to one or more embodiments of the present invention, a tubular outer layer body formed of a magnetic metal containing iron and a core body that is formed of a metal and has an outer diameter that is 85.1% or more and 99.4% or less of the inner diameter of the outer layer body are prepared, mechanical polishing is carried out on the inner surface of the outer layer body and the outer surface of the core body so as to form screw-shaped polishing marks around an axis of the core body, the core body is disposed inside the outer layer body to obtain a preform, and the preform is drawn through a wire drawing die, thereby obtaining a wire having a central conductor formed of the core body and an outer layer that is formed of the outer layer body and that covers the central conductor.

Next, the method for manufacturing a wire according to one or more embodiments will be described. In one or more embodiments described below, there will be a case where, for a common portion with the above-described embodiments, identical reference signs are given and a description thereof is not provided.

<Step of Producing Preform>

As shown in FIG. 2, a core body 11 and an outer layer body 12 are prepared.

On an outer surface 11a of the core body 11 and an inner surface 12a of the outer layer body 12, mechanical polishing is carried out.

The mechanical polishing can be carried out using, for example, a film, a drill, a brush, a polishing agent (abrasive grain), or the like. The mechanical polishing roughens the outer surface 11a of the core body 11 and the inner surface 12a of the outer layer body 12, and fine surface protrusions and recesses can be formed. In addition, the mechanical polishing removes an oxide film on the outer surface 11a of the core body 11 and the inner surface 12a of the outer layer body 12.

The mechanical polishing forms screw-shaped polishing marks around the axis of the core body 11 on the outer surface 11a of the core body 11 and roughens the surface. In order to form screw-shaped polishing marks (surface protrusions and recesses) on the outer surface 11a of the core body 11 and roughen the surface, it is possible to use a method in which at least one of the polishing tool (a film, a drill, a brush, or the like) and the core body 11 is rotated around the axis while being relatively moved in the axial direction of the core body 11.

The arithmetic surface roughness Ra (JIS B 0601 (2013)) of the outer surface 11a and the inner surface 12a that have been mechanically polished may be set to, for example, 10 μm or more and 200 μm or less.

When the mechanical polishing forms screw-shaped polishing marks (surface protrusions and recesses) on the outer surface 11a of the core body 11 and roughens the surface, in a wire drawing step described below, the joining of the core body 11 and the outer layer body 12 becomes easy. Therefore, when the wire 10 becomes fine in a wire drawing process, an excess stress does not apply to the outer layer 2, and wire drawing becomes possible without causing wire breakage.

At least one of the outer surface 11a of the core body 11 and the inner surface 12a of the outer layer body 12 may be treated with an acid. The treatment with an acid refers to a treatment with an acid treatment agent that is an inorganic acid or an aqueous solution of an inorganic acid. As the inorgnaic acid, for example, one or more of hydrochloric acid, nitric acid, sulfuric acid, and the like can be exemplified.

The concentration of the hydrochloric acid can be set to, for example, 0.1 mol/l to 12.1 mol/l (or 1 mol/l to 7 mol/l). The concentration of the nitric acid can be set to, for example, 0.1 mol/l to 14 mol/l (or 1 mol/l to 10 mol/l). The concentration of the sulfuric acid can be set to, for example, 0.1 mol/l to 18.25 mol/l (or 1 mol/l to 10 mol/l). The pH of the acid treatment agent is, for example, 2 or less.

The temperature condition of the treatment with an acid is, for example, 10° C. to 40° C., but the treatment with an acid may be carried out under a heating condition of higher than 40° C.

For the treatment with an acid, at least one of the core body 11 and the outer layer body 12 may be immersed in the acid treatment agent.

The treatment time of the treatment with an acid may be set to, for example, 1 to 30 minutes (or 1 to 10 minutes).

The treatment with an acid removes an oxide film on the outer surface 11a of the core body 11 and the inner surface 12a of the outer layer body 12. In a wire drawing step described below, the joining of the core body 11 and the outer layer body 12 becomes easy by the removal of the oxide film.

The treatment with an acid may be carried out on both the outer surface 11a of the core body 11 and the inner surface 12a of the outer layer body 12 or may be carried out only one of the outer surface 11a of the core body 11 and the inner surface 12a of the outer layer body 12.

The order of the treatment with an acid and the mechanical polishing is not particularly limited, and the treatment with an acid may be carried out earlier or the mechanical polishing may be carried out earlier.

In one or more embodiments, the treatment with an acid may not be carried out.

In the manufacturing method according to one or more embodiments, a preform 20A shown in FIG. 3 may also be used instead of the preform 20 shown in FIG. 2.

In the present step, similar to the above-described embodiments, the preform 20 is wire-drawn using the wire drawing die 30 shown in FIG. 4, thereby obtaining the wire 10 shown in FIG. 1.

In the manufacturing method according to the above-described embodiments, the preform 20 having the core body 11 disposed inside the outer layer body 12 is produced, and then the preform 20 is wire-drawn, thereby obtaining the wire 10.

According to the manufacturing method according to one or more embodiments, the concentration of an impurity in the outer layer 2 becomes smaller than that in a case where the outer layer is formed using a plating method. Therefore, the magnetic characteristic distribution of the outer layer 2 becomes uniform, and the magnetic characteristic do not easily degrade even when the outer layer 2 is formed to be thick. Therefore, in the case of applying the wire 10 to a coil in a high-frequency device, it is possible to avoid a decrease in the electric power transmission efficiency and the generation of heat caused by high-frequency resistance.

In addition, in the manufacturing method according to one or more embodiments, compared with the manufacturing method in which a plating method is used, the hardness of the outer layer 2 can be suppressed to be low. Therefore, during the coiling of the wire 10, the wire 10 does not easily break. Therefore, the wire 10 having excellent handleability can be obtained.

Furthermore, according to the manufacturing method according to one or more embodiments, compared with the manufacturing method in which a plating method is used, the time necessary to form the outer layer 2 can be shortened. In addition, it is also possible to cut the waste liquid treatment cost. Therefore, the manufacturing cost can be reduced.

The wire 10 is manufactured using the above-described manufacturing method, and thus an impurity (for example, chlorine or the like) is not easily mixed into the outer layer 2. The concentration of an impurity in the outer layer 2 is small, the magnetic characteristic distribution of the outer layer 2 becomes uniform, and the magnetic characteristic do not easily degrade even when the outer layer 2 is formed to be thick. Therefore, in the case of applying the wire 10 to a coil in a high-frequency device, it is possible to avoid a decrease in the electric power transmission efficiency and the generation of heat caused by high-frequency resistance.

In addition, in the wire 10, as described above, the hardness of the outer layer 2 can be suppressed to be low. Therefore, during the coiling of the wire 10, the wire 10 does not easily break. Therefore, the wire 10 having excellent handleability can be obtained.

Furthermore, as described above, the wire 10 is capable of reducing the manufacturing cost.

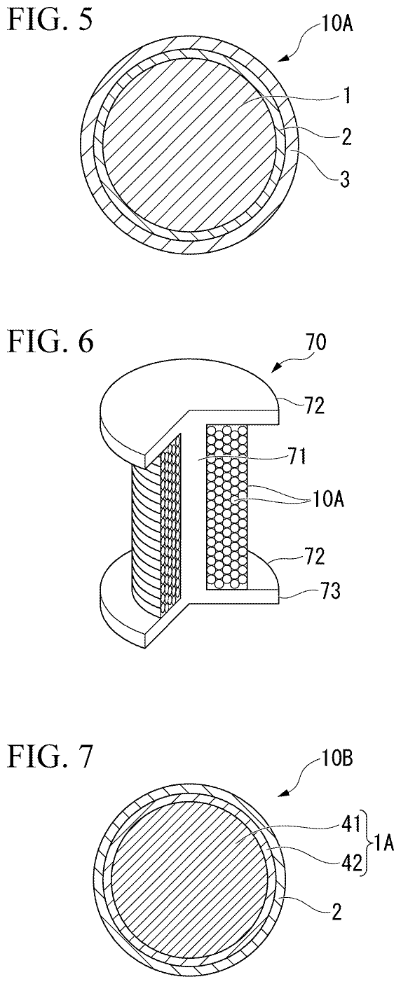

FIG. 5 is a cross-sectional view of a wire 10A that is a first modification example of the wire 10 in accordance with one or more embodiments.

The wire 10A is different from the wire 10 in FIG. 1 in terms of the fact that an insulating coating layer 3 is provided on the outer circumferential surface of the outer layer 2. The insulating coating layer 3 is formed of, for example, an insulating material such as a polyester, a polyurethane, a polyimide, a polyester-imide, or a polyamide-imide.

FIG. 6 shows an example of a high-frequency coil for which the wire in FIG. 5 is used in accordance with one or more embodiments. For a high-frequency coil 70 shown in FIG. 6, a support 73 having a trunk portion 71 and flange portions 72 formed at both ends of the trunk portion 71 is used. The wire 10A is wound around the trunk portion 71.

In other words, the high-frequency coil 70 has the wire 10A, the trunk portion 71, and the flange portions 72 formed at both ends of the trunk portion 71. The high-frequency coil 70 includes the support 73 in which the wire 10A is wound around the trunk portion 71.

For example, the high-frequency coil 70 may be manufactured by preparing the wire 10A and the support 73 having the trunk portion 71 and the flange portion 72 formed at both ends of the trunk portion 71 and winding the wire 10A around the trunk portion 71.

In FIG. 6, an example of using the wire 10A to manufacture the high-frequency coil 70 is shown, but the wire is not limited to the wire 10A, and, for example, the wire 10 and a wire 10B described below may also be used.

In addition, in the above-described example, an example of the support 73 provided with the flange portions 72 has been described, but a support not provided with any flange portion 72 may also be used.

In other words, the high-frequency coil may include a wire and a support having a trunk portion, and the wire may be wound around the trunk portion.

The high-frequency coil may be manufactured by preparing a wire and a support having a trunk portion and winding the wire around the trunk portion.

FIG. 7 is a cross-sectional view showing a wire 10B that is a second modification example of the wire 10 in accordance with one or more embodiments.

The wire 10B is different from the wire 10 in FIG. 1 in terms of the fact that a central conductor 1A is configured of a main portion conductor 41 and a conductor layer 42 formed on the outer circumferential surface of the main portion conductor 41. The main portion conductor 41 is formed of, for example, an aluminum-containing material or the like. The conductor layer 42 is formed of, for example, a copper-containing material or the like.

The above-described embodiments are examples of devices or methods for embodying the technical idea of the present invention, and the technical idea of the present invention does not limit the material, shape, structure, disposition, and the like of configurational components.

The ratio (diameter ratio) of the outer diameter of the core body to the inner diameter of the outer layer body may be a measurement value before the mechanical polishing and the acid treatment are carried out or may be a measurement value after at least one of the mechanical polishing and the acid treatment is carried out. Generally, the measurement values of the inner diameter of the outer layer body and the outer diameter of the core body rarely change before the mechanical polishing and the acid treatment and after the mechanical polishing and the acid treatment.

The wire 10 obtained using the manufacturing method according to the above-described embodiments is available in the electronic device industry including the manufacturing industry of a variety of devices such as non-contact power feeding devices or high-frequency current generation devices such as a high-frequency transformer, a motor, a reactor, a choke coil, an induction heating device, a magnetic head, a high-frequency power feeding cable, a DC power supply unit, a switching power supply, an AC adapter, an eddy-current detection-mode displacement sensor and flaw detection sensor, an IH cooking heater, a coil, and a power feeding cable.

The wire 10 can be used in, for example, a device that conducts a high-frequency current of 100 kHz or higher.

### EXAMPLES

### Test Examples 1 to 4, 7 to 12, and 15 to 18

The wire 10 shown in FIG. 1 was produced as described below.

As shown in FIG. 2, the core body 11 and the outer layer body 12 were prepared. In Test Examples 1 to 4 and 7 to 9, the core body 11 is formed of a copper-containing (Cu-based) material. In Test Examples 10 to 12 and 15 to 18, the core body 11 is formed of an aluminum-containing (Al-based) material.

The specification of the outer layer body 12 is shown in Table 2. The specification of the core body 11 is shown in Table 3. The lengths of the core body 11 and the outer layer body 12 were set to 80 cm.

The surfaces of the core body 11 and the outer layer body 12 were cleaned with a metal cleaner manufactured by Sankyo Chemical Co., Ltd.

In some of test examples of Test Examples 1 to 4, 7 to 12, and 15 to 18, one or both of the outer surface lla of the core body 11 and the inner surface 12a of the outer layer body 12 were treated with an acid.

In the treatment with an acid, hydrochloric acid (concentration: 7 mol/l) or nitric acid (concentration: 10 mol/l) was used as an acid treatment agent. Table 1 shows acid treatment agents used. Treatment times are also shown in parentheses.

Mechanical polishing was carried out on the outer surface 11a of the core body 11 and the inner surface 12a of the outer layer body 12.

In the mechanical polishing, a file or a rotary drill was used as a polishing tool. As the file, #240 manufactured by Refine Tec Ltd. was used. As the rotary drill, Hitachi Electronics hand grinder (KC-20) manufactured by Koki Holdings Co., Ltd. was used. In any case of the file or the rotary drill, the core body 11 and the outer layer body 12 were polished in the longitudinal direction or a screw direction at a range of 50 mm/s.

In the case of using the file, polishing marks (surface protrusions and recesses) were formed in the longitudinal direction of the core body 11 and the outer layer body 12 on the outer surface lla of the core body 11 and the inner surface 12a of the outer layer body 12. In the case of using the rotary drill, screw-shaped polishing marks (surface protrusions and recesses) were formed around the axis of the core body 11 on the outer surface 11a of the core body 11.

The core body 11 is inserted into the cylindrical outer layer body 12, thereby obtaining the preform 20.

As shown in FIG. 4, the preform 20 was wire-drawn stepwise through a plurality of wire drawing dies 30, thereby obtaining the wire 10. The area reduction ratio in the wire drawing process by one time was set to 10% to 20%.

In Test Examples 1 to 4 and 7 to 9, the outer diameter of the wire 10 is 0.4 mm.

In Test Examples 10 to 12 and 15 to 18, the outer diameter of the wire 10 is 1.0 mm.

For the wire 10, the relative magnetic permeability of the outer layer 2 was measured.

The relative magnetic permeability was measured using a VSM device manufactured by Toei Scientific Industrial Co., Ltd. Measurement conditions are as described below.

Magnetic field application direction: Longitudinal direction of wire

Magnetic field range: −8×10⁵ to 8×10⁵ A/m

Measurement location of relative magnetic permeability: 1×10⁴ A/m

For the wire 10, the Vickers hardness of the outer layer 2 was measured.

The Vickers hardness was measured using a Vickers hardness tester (Vickers tester HM-200 manufactured by Mitutoyo Corporation) at a test force of 0.1 to 0.5 N for a holding times of 15 seconds.

For the wire 10, the thickness of the outer layer 2 was measured.

The results are shown in Table 1.

In Table 1, “diameter ratio” indicates the ratio of the outer diameter D11 of the core body 11 to the inner diameter D12 of the outer layer body 12 in FIG. 2, that is, “D11/D12”.

“Wire drawing process” was evaluated as “favorable” in a case where the wire drawing was possible without any problems. In addition, in a case where wire breakage occurred in the wire drawing process, “wire breakage” was indicated.

### Test Examples 5, 6, 13, and 14

Wires were produced by forming an outer layer on the outer circumferential surfaceof a central conductor using a plating method.

In Test Examples 5 and 6, the central conductors (outer diameter: 0.4 mm) were formed of an aluminum-containing material. In Test Examples 13 and 14, the central conductors (outer diameter: 1.0 mm) were formed of a copper-containing material. The outer diameter of the central conductor 1 is 1.0 mm.

In all of the test examples (Test Examples 5, 6, 13, and 14), the outer layers were formed of iron (Fe).

Plating conditions are as described below.

Composition of plating liquid: FeCl₂.4H₂O (300 g/l), CaCl₂ (335 g/l)

Bath temperature: 90° C.

Current density: 6.5 A/dm²

pH: 1.0

The results are shown in Table 1.

TABLE 1

| | | | | Mechanical polishing of core | | Mechanical polishing of outer | | | | | Relative magnetic | Hardness of | Thickness of |
|---|---|---|---|---|---|---|---|---|---|---|---|---|---|
| Test | Outer layer | | Diameter | body | | layer body | | Treatment with acid | | Wire drawing | permeability | outer layer | outer layer |
| Example | body | Core body | ratio | Direction | Tool | Direction | Tool | Outer layer body | Core body | process | (−) | (Hv) | (μm) |
| 1 | Pipe 1 | Bar 1 | 80.0 | Longitudinal | File | Longitudinal | File | None | None | Wire breakage | — | — | — |
| | | (Cu-based) | | | | | | | | | | | |
| 2 | Pipe 1 | Bar 1 | 80.0 | Longitudinal | File | Longitudinal | File | Hydrochloric | None | Wire breakage | — | — | — |
| | | (Cu-based) | | | | | | acid (1 min) | | | | | |
| 3 | Pipe 3 | Bar 1 | 85.1 | Longitudinal | File | Longitudinal | File | Hydrochloric | None | Wire breakage | — | — | — |
| | | (Cu-based) | | | | | | acid (10 min) | | | | | |
| 4 | Pipe 3 | Bar 1 | 85.1 | Longitudinal | File | Longitudinal | File | None | None | Wire breakage | — | — | — |
| | | (Cu-based) | | | | | | | | | | | |
| 5 | (Plating) | — | — | — | — | — | — | — | — | — | 108.0 | 373.2 | 1.0 |
| 6 | (Plating) | — | — | — | — | — | — | — | — | — | 66.1 | 361.9 | 3.0 |
| 7 | Pipe 3 | Bar 1 | 85.1 | Longitudinal | File | Longitudinal | File | Hydrochloric | None | Favorable | 98.2 | 320.7 | 16.1 |
| | | (Cu-based) | | | | | | acid (1 min) | | | | | |
| 8 | Pipe 3 | Bar 1 | 85.1 | Screw | Rotary | Longitudinal | File | None | None | Favorable | 107.5 | 283.4 | 15.9 |
| | | (Cu-based) | | | drill | | | | | | | | |
| 9 | Pipe 3 | Bar 2 | 99.4 | Screw | Rotary | Longitudinal | File | None | None | Favorable | 103.7 | 318.3 | 16.0 |
| | | (Cu-based) | | | drill | | | | | | | | |
| 10 | Pipe 3 | Bar 3 | 93.6 | Longitudinal | File | Longitudinal | File | None | None | Wire breakage | — | — | — |
| | | (Al-based) | | | | | | | | | | | |
| 11 | Pipe 3 | Bar 4 | 95.7 | Longitudinal | File | Longitudinal | File | None | None | Wire breakage | — | — | — |
| | | (Al-based) | | | | | | | | | | | |
| 12 | Pipe 1 | Bar 6 | 95.0 | Longitudinal | File | Longitudinal | File | None | None | Wire breakage | — | — | — |
| | | (Al-based) | | | | | | | | | | | |
| 13 | (Plating) | — | — | — | — | — | — | — | — | — | 105.5 | 370.1 | 1.0 |
| 14 | (Plating) | — | — | — | — | — | — | — | — | — | 57.8 | 368.2 | 3.0 |
| 15 | Pipe 3 | Bar 7 | 95.7 | Longitudinal | File | Longitudinal | File | Hydrochloric | Hydrochloric | Favorable | 100.4 | 239.3 | 40.1 |
| | | (Al-based) | | | | | | acid (10 min) | acid (10 min) | | | | |
| 16 | Pipe 3 | Bar 8 | 99.4 | Longitudinal | File | Longitudinal | File | Hydrochloric | None | Favorable | 98.5 | 235.8 | 40.1 |
| | | (Al-based) | | | | | | acid (10 min) | | | | | |
| 17 | Pipe 3 | Bar 5 | 99.4 | Longitudinal | File | Longitudinal | File | Hydrochloric | None | Favorable | 109.4 | 212.5 | 39.8 |
| | | (Al-based) | | | | | | acid (1 min) | | | | | |
| 18 | Pipe 3 | Bar 5 | 99.4 | Screw | Rotary | Longitudinal | File | None | None | Favorable | 96.3 | 256.7 | 40.0 |
| | | (Al-based) | | | drill | | | | | | | | |

TABLE 2

| | | Outer diameter | Inner diameter | Thickness | | |
|---|---|---|---|---|---|---|
| | Product name | (mm) | (mm) | (mm) | Maker | Others |
| Pipe 1 | PC | 11.0 | 10.0 | 0.5 | Nippon Kinzoku | — |
| | PERMALLOY | | | | Co., Ltd. | |
| Pipe 2 | PC | 11.0 | 10.0 | 0.5 | Nippon Kinzoku | Thermal |
| | PERMALLOY | | | | Co., Ltd. | treatment in |
| | | | | | | nitrogen gas |
| | | | | | | (600° C., |
| | | | | | | three hours) |
| Pipe 3 | STKM11A_E-C | 10.0 | 9.4 | 0.3 | JFE Corporation | — |

TABLE 3

| | | Outer | | |
|---|---|---|---|---|
| | Product name | diameter | | Process conditions |
| | or the like | (mm) | Maker | Others |
| Bar 1 | SCR | 8.0 | Fujikura Ltd. | — |
| Bar 2 | C1100 | 9.35 | Koyama Tekko | Wire drawn from ϕ10 |
| | | | Co., Ltd. | mm to ϕ9.35 mm |
| Bar 3 | 1050A1 | 8.8 | Aluminum Wire | Wire drawn from ϕ12 |
| | | | Rod Company Ltd. | mm to ϕ8.8 mm |
| Bar 4 | 1050A1 | 9.0 | Aluminum Wire | Wire drawn from ϕ12 |
| | | | Rod Company Ltd. | mm to ϕ9 mm |
| Bar 5 | 1050A1 | 9.35 | Aluminum Wire | Wire drawn from ϕ12 |
| | | | Rod Company Ltd. | mm to ϕ9.35 mm |
| Bar 6 | 1050A1 | 9.5 | Aluminum Wire | Wire drawn from ϕ12 |
| | | | Rod Company Ltd. | mm to ϕ9.5 mm |
| Bar 7 | (High-strength | 9.0 | Fujikura Ltd. | Annealed material |
| | A1 wire) | | | |
| Bar 8 | (High-strength | 9.35 | Fujikura Ltd. | Hard material |
| | A1 wire) | | | |

As shown in Table 1, in Test Examples 7 and 15 to 17, the diameter ratios “D11/D12” between the core body 11 and the outer layer body 12 are in a range of 85.1% or more and 99.4% or less. In Test Examples 7 and 15 to 17, the mechanical polishing was carried out on the outer surface 11a of the core body 11 and the inner surface 12a of the outer layer body 12. Furthermore, the treatment with hydrochloric acid was carried out at least on the outer surface 11a of the core body 11.

In Test Examples 7 and 15 to 17, it was confirmed that, unlike Test Examples 5, 6, 13, and 14 in which the outer layers were formed using a plating method, the relative magnetic permeability could be set to a high value even in a case where the outer layer 2 was thick. In addition, in Test Examples 7 and 15 to 17, the hardness of the outer layer 2 was low.

As shown in Table 1, in Test Examples 8, 9, and 18, the diameter ratios “D11/D12” between the core body 11 and the outer layer body 12 are in a range of 85.1% or more and 99.4% or less. In Test Examples 8, 9, and 18, the mechanical polishing was carried out on the outer surface 11a of the core body 11 and the inner surface 12a of the outer layer body 12. In addition, in Test Examples 8, 9, and 18, screw-shaped polishing marks (surface protrusions and recesses) were formed on the outer surfaces 11a of the core bodies 11.

In Test Examples 8, 9, and 18, it was confirmed that, unlike Test Examples 5, 6, 13, and 14 in which the outer layers were formed using a plating method, the relative magnetic permeability could be set to a high value even in a case where the outer layer 2 was thick. In addition, in Test Examples 8, 9, and 18, the hardness of the outer layer 2 was low.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.
1 . . . CENTRAL CONDUCTOR,
2 . . . OUTER LAYER,
11 . . . CORE BODY,
12, 12A . . . OUTER LAYER BODY,
10, 10A, 10B . . . WIRE,
20, 20A . . . PREFORM

1. A method for manufacturing a wire, the method comprising:
preparing a tubular outer layer body comprising a magnetic metal containing iron;
preparing a metal core body having an outer diameter that is 85.1% or more and 99.4% or less of an inner diameter of the tubular outer layer body;
mechanically polishing an inner surface of the tubular outer layer body and an outer surface of the metal core body;
treating at least one of the inner surface of the tubular outer layer body and the outer surface of the metal core body with hydrochloric acid;
obtaining a preform by disposing the metal core body inside the tubular outer layer body; and
obtaining a wire by drawing the preform through a wire drawing die, wherein
the wire comprises:
the metal core body as a central conductor; and
the tubular outer layer body as an outer layer that covers the central conductor.

2. A method for manufacturing a wire, the method comprising:
preparing a tubular outer layer body comprising a magnetic metal containing iron;
preparing a metal core body having an outer diameter that is 85.1% or more and 99.4% or less of an inner diameter of the tubular outer layer body;
mechanically polishing an inner surface of the tubular outer layer body;
forming a screw-shaped polishing mark around an axis of the metal core body by mechanically polishing an outer surface of the metal core body;
obtaining a preform by disposing the metal core body inside the tubular outer layer body; and
obtaining a wire by drawing the preform through a wire drawing die, wherein
the wire comprises:
the metal core body as a central conductor; and
the tubular outer layer body as an outer layer that covers the central conductor.

3. The method for manufacturing a wire according to claim 2, further comprising:
treating at least one of the inner surface of the tubular outer layer body and the outer surface of the metal core body with an acid.

4. The method for manufacturing a wire according to claim 1, wherein
in the drawing of the preform, an area reduction ratio is 10% or more and 20% or less in a single pass through the wire drawing die.

5. A wire comprising:
a metal central conductor; and
an outer layer that:
comprises a magnetic metal containing iron;
has a thickness of 3 μm or more;
has a Vickers Hardness of less than 350 Hv; and
covers the central conductor.

6. The wire according to claim 5, wherein
a Cl concentration of the outer layer is 0.1 wt % or less.

7. A high-frequency coil comprising:
th wire according to claim 5; and
a support comprising a trunk portion around which the wire is wound.

8. A method for manufacturing a high-frequency coil, comprising:
preparing the wire according to claim 5;
preparing a support comprising a trunk portion; and
winding the wire around the trunk portion.

9. The method for manufacturing a wire according to claim 2, wherein
in the drawing of the preform, an area reduction ratio is 10% or more and 20% or less in a single pass through the wire drawing die.

10. The method for manufacturing a wire according to claim 3, wherein
in the drawing of the preform, an area reduction ratio is 10% or more and 20% or less in a single pass through the wire drawing die.
